(19) United States
(12) Patent Application Publication
(10) Pub. No.: US 2024/0336385 A1
(43) Pub. Date: Oct. 10, 2024

(54) DEVICE FOR THE TRANSFER OF POUCHES FROM A POUCH INFEED TO A CIRCULATION SYSTEM OF A POUCH PACKAGING MACHINE, A CORRESPONDING POUCH PACKAGING MACHINE AND A CORRESPONDING METHOD

(71) Applicant: SN Maschinenbau GmbH, Wipperfürth (DE)

(72) Inventor: Jürgen BEINGHAUS, Wipperfürth (DE)

(21) Appl. No.: 18/626,839

(22) Filed: Apr. 4, 2024

(30) Foreign Application Priority Data
Apr. 6, 2023 (EP) 23166939.1

(51) Int. Cl. B65B 43/46; B65B 43/52

(52) U.S. Cl. CPC B65B 43/465; B65B 43/52

(57) ABSTRACT

A device for the transfer of pouches from a pouch feed to a circulation system of a pouch packaging machine, wherein the device has a conveyor for the horizontal transport of individual empty pouches, wherein the conveyor has a lifting element on the downstream side in its conveying direction (x) for lifting a first edge of a pouch. A corresponding pouch packaging machine and a corresponding method are further described.

### CROSS-REFERENCE TO RELATED APPLICATIONS

This application claims the benefit and priority of European Patent Application No. 23166939.1 filed Apr. 6, 2023. The entire disclosure of the above application is incorporated herein by reference.

### BACKGROUND OF THE INVENTION

### Technical Field

The invention relates to a device for the transfer of pouches from a pouch infeed to a circulation system of a pouch packaging machine. A corresponding pouch packaging machine and a corresponding method are further described.

### Discussion

DE 20 2014 102 116 U1 describes a pouch packaging machine with a rotary conveyor system for the aligned transport of pouches between packaging stations of the packaging machine. The pouches are usually transported by the rotary conveyor system in a clocked manner between the packaging stations of the packaging machine. More and more packaging machines are becoming established in which the pouches are transported by the rotary conveyor system in a continuous movement between the packaging stations. Compared to clocked systems, continuous systems have the advantage of lower wear and better energy efficiency. This has the consequence that the feeding of the empty pouches into the circulation system should be designed both for the clocked and for the continuous operation of the packaging machine in order to be able to operate both clocked and continuous systems.

### BRIEF SUMMARY OF THE INVENTION

It is therefore the aspect of the invention to provide a device for the transfer of pouches from a pouch infeed to a circulation system of a pouch packaging machine which is suitable both for the continuous and for the clocked transfer of empty pouches.

This aspect is solved by a device having the features of claim 1. A corresponding pouch packaging machine is the subject matter of claim 11 and a corresponding method is the subject matter of claim 12. Advantageous embodiments are subject matter of the dependent claims.

Accordingly, it is provided in the device that it has a conveyor for the horizontal transport of individual empty pouches, wherein the conveyor has a lifting element on the downstream side in its conveying direction for lifting a first edge of the pouch.

The conveyor, in particular its conveying speed in its conveying direction, and the circulation system, in particular its circulation speed, can be operated independently of one another. The circulation speed of the circulation system can depend on the cycle speed of the pouch packaging machine. The conveying speed can be adjusted depending on the cycle speed. The conveyor can be configured to provide the circulation system with the horizontal empty pouches with the lifted first edge at a speed adapted to the circulation speed of the circulation system, so that the circulation system can remove the empty pouches at the first edge from the conveyor. The circulation system and the conveyor can run synchronously at least in sections in a transfer region. The circulation system and the conveyor can have a very low or no relative speed to one another in the transfer region. In the transfer region, the empty pouches can have the lifted first edge. It can be provided that the lifting element is arranged in the transfer region. The circulation system can be configured to grip a pouch in the transfer region at the first lifted edge and to remove it from the conveyor.

The conveyor can have a continuous conveying speed or a clocked conveying speed in the conveying direction.

The empty pouches can be provided in particular as film pouches, for example as flat pouches, side-fold pouches and/or stand-up pouches. The empty pouches can be provided in particular in a flat and/or folded state. In particular, for the particularly reliable transport with the conveyor and the particularly reliable removal from the conveyor with the aid of the circulation system the pouches can have a first edge which is formed as a straight first edge. The horizontal empty pouch can have a thickness perpendicular to the film plane, for example in the vertical direction when the pouch is transported by the conveyor, which is very much smaller than an edge length, for example smaller than the length of the first edge of the pouch. The horizontal empty pouch can therefore extend substantially in the horizontal and have an only insignificant thickness in the vertical direction in comparison with its horizontal extent.

The lifting element can be any desired lifting element which is configured to lift the first edge of the pouch out of the horizontal plane of the horizontal pouch, so that it is freely accessible to a gripper of the circulation system, in particular is lifted from a support of the conveyor on which the pouch rests in the conveyor.

The lifting element can have a ramp or run-on slope rising along the conveying direction. In one embodiment, the lifting element can have a stop tapering the conveying width of the conveyor perpendicular to the conveying direction in the conveying direction for a first edge of a pouch to be lifted. The stop can preferably be adjustable in the direction perpendicular to the conveying direction. The stop can be adjustable in particular in a horizontal direction. The stop can be adjustable in said direction with the aid of an actuating drive. With the aid of the adjustability of the stop, the conveyor can be set to a given pouch height. The pouch height can be regarded as the length of a side wall of the pouch which is dimensioned between the pouch base and the first edge. The pouch is preferably transported by the conveyor in a horizontal and folded state, wherein the height of the pouch extends in the horizontal and perpendicular to the conveying direction.

The pouch infeed can comprise a pouch magazine and/or a pouch production and is not restricted to any particular embodiments. The pouch infeed can be or comprise, for example, a device for preprocessing film pouches. The pouch infeed can be configured to hold preproduced pouches and to separate them in order to feed them into the device.

In a preferred embodiment, the minimum conveying width can be smaller by one dimension than a pouch height between pouch base and opening of a pouch to be transported, around which the first edge of the pouch to be transported is to be lifted.

The conveyor can have a holding means, which is designed to hold a pouch on a second edge opposite the first edge. The holding means can have a fixed height stop and a first belt conveyor, which enclose between them a holding gap extending in the conveying direction for receiving and guiding the second edge.

The conveyor can have a first belt conveyor, which is in frictional engagement with a second edge opposite the first edge. Alternatively or additionally, the first belt conveyor can be a cleated belt, with which the horizontal empty pouches are transported in the conveying direction.

The conveyor can be configured to stretch out the pouch, but exclusively at the first edge, in its pouch plane, preferably in a horizontal plane, so that the first edge remains freely movable. It is thereby made possible, for example, that the pouch on the one hand can be transported particularly reliably on the conveyor and on the other hand the first edge can likewise be lifted reliably by the lifting element, in particular into a position lifted out of the horizontal plane.

The conveyor can have a first belt conveyor, which engages on a second edge opposite the first edge. The conveyor can have a second belt conveyor, which engages on the pouch at a distance from the first edge. The dimension can correspond to the portion of the height of the pouch extending from the first edge, which portion is provided to be lifted by the lifting element, preferably out of a horizontal orientation into a position lifted with respect thereto.

The first belt conveyor and/or the second belt conveyor can have a circulating cleated belt. If the conveyor has a first belt conveyor and a second belt conveyor, these preferably have the same circulation speed. If the first belt conveyor and the second belt conveyor furthermore each have a circulating cleated belt, the cleats of the two cleated belts can be synchronized, so that they are arranged opposite one another at the same height in the conveying plane perpendicular to the conveying direction.

The second belt conveyor can have an upper belt conveyor and a lower belt conveyor. Between the upper belt conveyor and in the lower belt conveyor, the first pouch edge can be in frictional engagement with the upper and/or the lower belt conveyor. The upper and the lower belt conveyor preferably have the same feed speed, in particular they can be concurrent. Accordingly, the transport belts of the upper and the lower belt conveyor can have no relative speed to one another. Between the upper belt conveyor and in the lower belt conveyor, a contact pressure can be provided, which holds the first pouch edge, preferably in frictional engagement.

A pouch packaging machine can have a circulation system with a plurality of pouch grippers spaced apart at a distance from one another in the transport direction of the circulation system. The pouch packaging machine can further have a pouch infeed and a device of the type described above. The conveyor can open in its conveying direction downstream into an access region of the circulation system. In the access region, a pouch gripper of the circulation system can come into engagement with a lifted first edge of a pouch transported lying by the conveyor. Preferably, but not necessarily, the pouch gripper can be guided in a vertical plane along the circulation system. It can be provided here that the pouch gripper is guided in the access region along a vertical circular path section. It is thereby achieved that the pouch gripper is pivoted along a circular path toward the lifted first edge of the pouch, so that the edge is positioned for example between gripper jaws of the gripper spaced apart from one another in an open position of the pouch gripper. The pouch gripper can preferably be actuated in a lowermost position of the vertical circular path section, in which the pouch gripper is arranged substantially horizontally and with its gripper jaws parallel to the first edge, to be transferred from the open position of the gripper jaws into a closed position, in which the gripper jaws are approached to one another and hold the first edge between them.

In a method for transferring pouches from a pouch infeed to a circulation system of a pouch packaging machine, the following steps can be provided:
a) providing a plurality of pouches arranged lying with a pouch infeed;
b) sequentially transferring the lying pouches to a device of the type described above;
c) transporting the pouches lying with a conveyor of the device in a conveying direction; and
d) sequentially lifting in each case a first edge of the pouches.

For said lifting, the first edge of the pouch can run onto a ramp of the conveyor rising along the conveying direction or onto a run-on slope of the conveyor.

For said lifting, the first edge can be guided with the conveyor along a stop tapering the conveying width of the conveyor perpendicular to the conveying direction in the conveying direction.

The method can further comprise gripping the lifted first edge of the pouch with a pouch gripper of the circulation system. Preferably, but not necessarily, the pouch gripper is guided here in a vertical plane along the circulation system. Particularly preferably, but not necessarily, the pouch gripper is pivoted along a vertical circular path section onto the lifted first edge of the pouch.

While the edge is preferably arranged in a horizontal plane of the lying pouch before said lifting, it can be pivoted upwards in its lifted position by at least 45°, preferably by at least 60° and particularly preferably by at least 80°. In one embodiment, the first edge is pivoted out of the horizontal by 90° in the lifted position, thus aligned substantially perpendicularly.

### BRIEF DESCRIPTION OF THE DRAWINGS

Further details of the invention are explained with reference to the following figures. In the figures:

FIG. 1 shows an exemplary embodiment of a device for the transfer of pouches from a pouch infeed to a circulation system;

FIG. 2 shows a detail of a pouch packaging machine according to an embodiment of the invention;

FIG. 3 shows schematically the lifting of the first edge and the transfer of the pouch to a circulation system according to an embodiment of the invention;

FIG. 4 shows a detail of a further embodiment of a pouch packaging machine with a vertically guided circulation system and an additional rotary conveyor system; and

FIG. 5 shows a detail of a further embodiment of a pouch packaging machine with a horizontally guided circulation system.

### DESCRIPTION OF THE PREFERRED EMBODIMENTS OF THE INVENTION

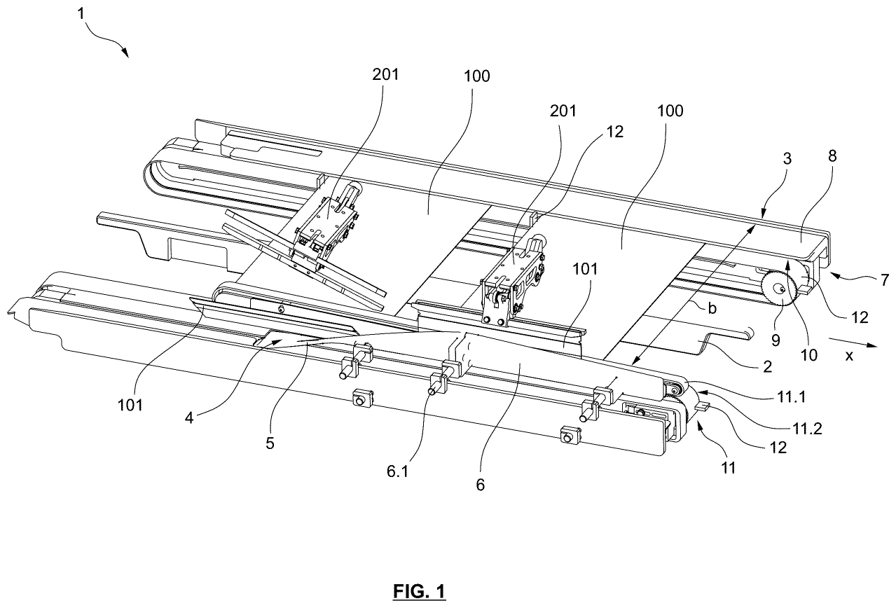

FIG. 1 shows an exemplary embodiment of a device according to the invention. The invention is not restricted either to the embodiment according to FIG. 1 or to one of the embodiments shown in the other figures.

In the embodiment of the device 1 according to FIG. 1, film pouches 100 are transported lying in the conveying direction x as empty, folded, thus flat pouches 100. The pouches can be provided for example as stand-up pouches with folded stand-up. The horizontal pouches can therefore have a thickness in the vertical direction which is substantially smaller than each of the edge lengths of the pouch 100. The thickness can be a few millimeters, for example 2 mm. The pouch 100 has a first edge 101, on which the opening of the pouch is provided. The first edge 101 thus forms an upper edge of the pouch 100, so that the opening is a filling opening of the pouch 100 for filling the pouch 100. The opening can be provided in that two side walls forming the side walls of the pouch 100 are not sealed to one another in the region of the opening, while the side walls have a sealing seam on their two outer edges and on the base, for example on the stand-up.

During the transport of the pouches 100 in the conveying direction x, the pouches 100 run onto a lifting element 4 for lifting the first edge 101 of the pouch 100. In the present case, the lifting means 4 is formed as a rising ramp or as a run-on slope. In addition, the lifting element 4 has a stop 6 tapering the conveying width b of the conveyor perpendicular to the conveying direction x in the conveying direction x. The stop has a vertical flange, against which the first edge 101 comes to bear. The stop 6, in particular the vertical flange, can be adjusted with the aid of an actuating drive 6.1 in the conveying direction x, in order to set the lifting element 4, in particular the stop 6, to a given pouch height, measured between the pouch base and the first edge 101 or the opening of the pouch.

It can be seen that the circulation system 200 has pouch grippers 201 with in each case a pair of gripper jaws, which are configured to grip the pouch 100 at the lifted first edge 101. Since the pouch 100 is preferably a flexible part, the gripper jaws preferably have a length which extends substantially over the entire length of the first edge 101, so that the pouch 100 experiences stabilization by gripping at the first edge 101.

The height of the pouch 100 between the pouch base and the pouch opening therefore extends in the direction of the conveying width b of the conveyor 3. The pouches 100 are thus transported in the conveying direction x in the horizontal and perpendicular to their height.

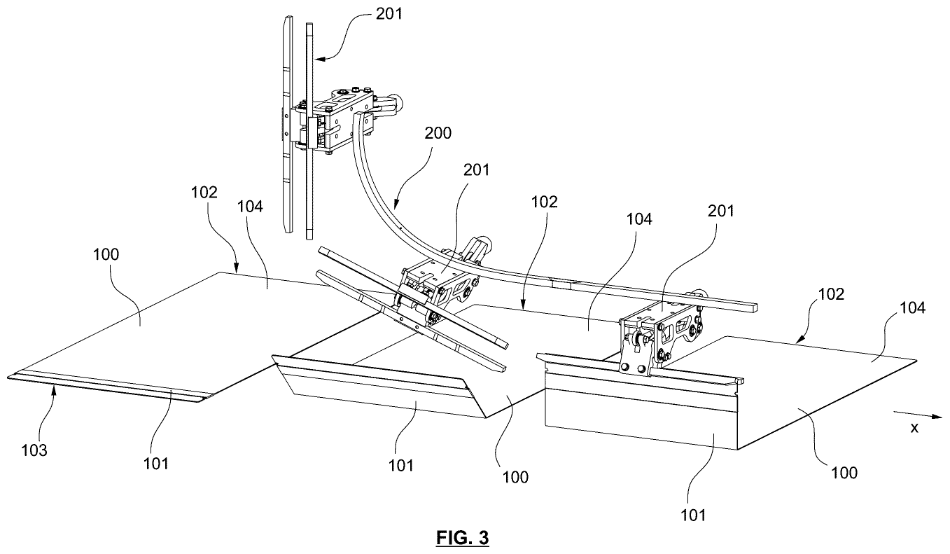

The conveyor 3 has a holding means 7, which is designed to hold the pouch 100 on its second edge 104 opposite the first edge 101 (cf. FIG. 3). The holding means 7 has a fixed height stop 8 and a first belt conveyor 9. The height stop 8 and the belt conveyor 9 enclose between them a holding gap 10 extending in the conveying direction x for receiving the second edge 104 of the pouch 100. For advancing the pouches 100 in the conveying direction x, the belt conveyor 9 has a cleated belt 12. The second edge 104 is received freely in the gap 10, so that the film pouch can be driven by the cleated belt 12 without being compressed. The conveyor can be configured in particular to stretch out the pouch 100, exclusively at the first edge 101, in its pouch plane, so that it is provided as a flat pouch. Furthermore, it is ensured that the first edge 101 remains freely movable.

The stretching can be restricted to the pouch 100 being held on the second edge 104 opposite the first edge 101 by the conveyor 3, for example being received freely in the gap 10, but restricted in its freedom of movement in the vertical direction.

In the illustrated embodiment, the conveyor 3 further has, in addition to the first belt conveyor 9, a second belt conveyor 11.1, 11.2, which engages on a pouch 100 at a distance from the first edge 101. It can thereby be ensured that the first edge 101 remains freely movable, to be able to be lifted out of the horizontal when the lifting element 4 is started up.

A runner 2 supports the pouch 100, which is a flexible part, in a region between the first belt conveyor 9 and the second belt conveyor 11.1, 11.2.

The second belt conveyor 11.1, 11.2 has an upper belt conveyor 11.1 and a lower belt conveyor 11.2. Between the upper belt conveyor 11.1 and in the lower belt conveyor 11.2, the pouch edge 101 is in frictional engagement with the belt conveyors 11.1, 11.2. The two belt conveyors 11.1, 11.2 preferably have the same feed speed, in particular they can be concurrent. Accordingly, the transport belts of the belt conveyors 11.1, 11.2 can have no relative speed to one another. Between the upper belt conveyor 11.1 and in the lower belt conveyor 11.2, a contact pressure can be provided, which holds the pouch edge 101, preferably in frictional engagement.

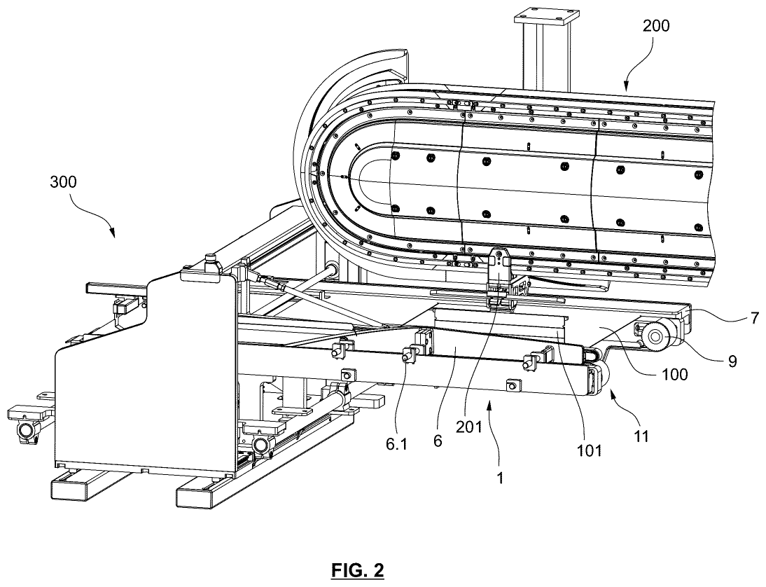

FIG. 2 shows an arrangement comprising a device 1 and a circulation system 200 and a pouch infeed 300. The pouch infeed 300 can comprise a pouch magazine and/or a pouch production and, like the circulation system 200, is not restricted to any particular embodiments. The pouch infeed 300 can be or comprise, for example, a device for preprocessing film pouches. The pouch infeed 300 can likewise be configured to hold preproduced pouches and to separate them in order to feed them into the device 1.

In the present embodiment, the circulation system 200 is formed with a vertical circulation plane, within which grippers 201 are guided in a circular or elliptical path. In a variant of the embodiment according to FIG. 2, the device 1 is formed corresponding to the device 1 according to FIG. 1.

FIG. 3 shows schematically an exemplary transfer process of pouches 100, which are transported in a device according to the invention in the conveying direction x. The pouch 100 arranged furthest to the left in the illustration according to FIG. 3 is arranged in a completely horizontal orientation. All outer edges, including the base 102 and the opening 103, are arranged in the same plane, in the present case in the horizontal plane. In contrast, the first edge 101 of the middle pouch 100 is located in a position in which it is partially folded out of the horizontal. While remaining portions of the pouch 100 are still held in the horizontal, the edge 101 is pivoted upward out of the horizontal by an angle of less than 90°. Synchronously with the advance of the pouches 100 in the conveying direction x, grippers 201 of the circulation system 200 are transported along a vertical circular arc and are approached to the pouches 100.

The pouch 100 arranged very to the right in FIG. 3 has a first edge 101 pivoted out of the horizontal by 90°, thus the edge 101 is aligned vertically and extends correspondingly perpendicularly to the remaining portions of the pouch 100. At the same time, both the gripper 201 and the edge 101 have been further approached, so that in the relative arrangement of edge 101 and gripper 201 in the pair of gripper 201 and pouch 100 furthest to the right according to FIG. 3, the edge 101 is pivoted into the gripper 201, in particular between the gripper jaws of the gripper, and the gripper 201 can grip the edge 101 reliably and lift the pouch 100 for further conveying from the conveyor 3 (not shown).

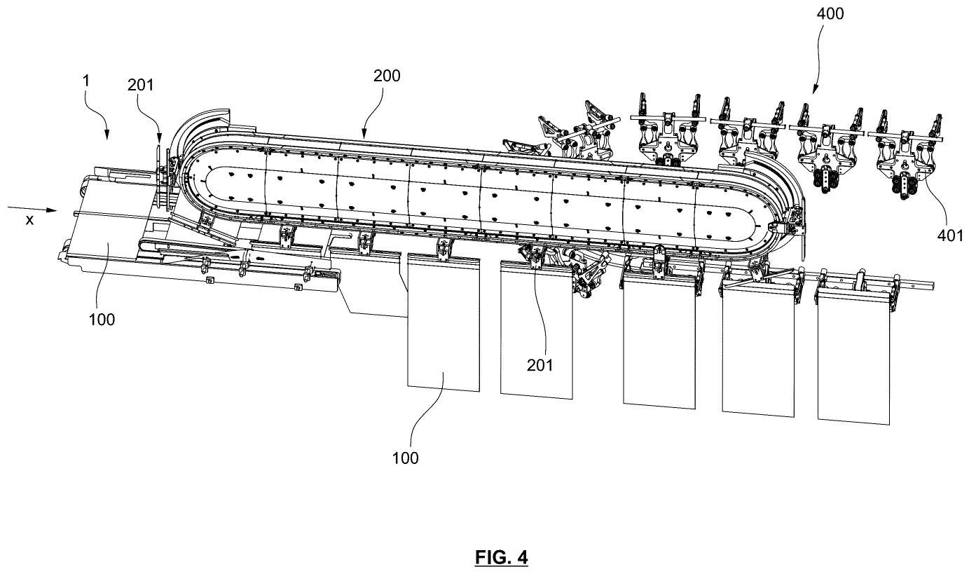

FIG. 4 shows that after the transfer from the pouch 100 to the circulation system 200, the pouches can be transferred a further time to a rotary conveyor system 400 with a plurality of circulating grippers 401. The rotary conveyor system can be, for example, an embodiment as known from DE 20 2014 102 116 U1. While the grippers 201 of the circulation system 200 are transported in a vertical plane, the grippers 401 of the rotary conveyor system 400 are conveyed in a horizontal plane.

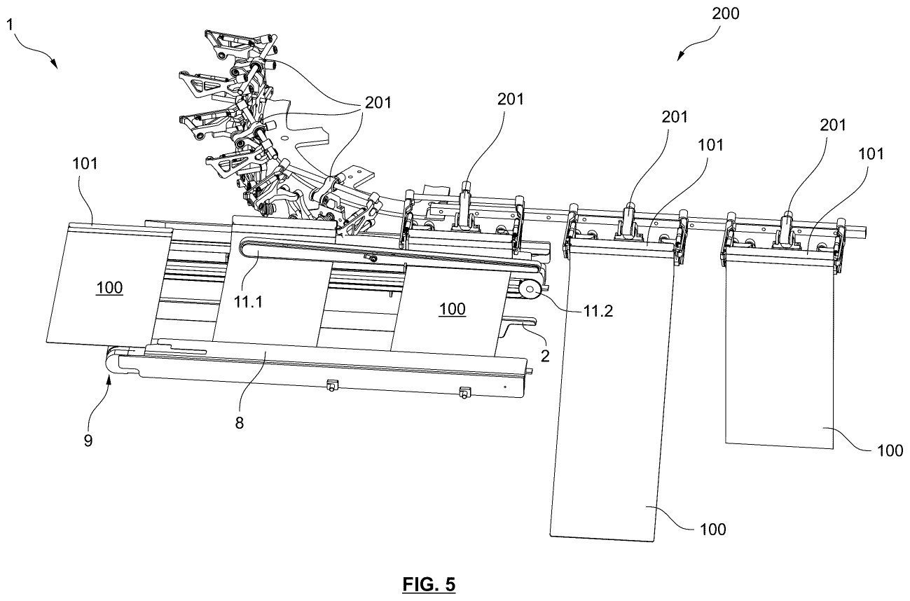

FIG. 5 shows a further embodiment in which, in contrast to the embodiment according to FIG. 4, the circulation system 200 is guided horizontally and not vertically. Accordingly, the circulation system 200 according to FIG. 5 can be formed as a rotary conveyor system 400 (cf. FIG. 4) with which the pouch 100 is fed to processing stations of a pouch packaging machine, for example a filling station, a sealing station or the like.

The features of the invention disclosed in the above description, in the drawing and in the claims can be essential both individually and in any desired combination for the implementation of the invention.

1. A device (1) for the transfer of pouches (100) from a pouch feed (300) to a circulation system (200) of a pouch packaging machine, wherein the device (1) has a conveyor (3) for the horizontal transport of individual empty pouches (100), wherein the conveyor (3) has a lifting element (4) on the downstream side in its conveying direction (x) for lifting a first edge (101) of a pouch (100).

2. The device (1) according to claim 1, in which the lifting element (4) has a ramp (5) or run-on slope rising along the conveying direction.

3. The device (1) according to claim 1, in which the lifting element (4) has a stop (6) tapering the conveying width (b) of the conveyor (3) perpendicular to the conveying direction (x) in the conveying direction (x) for a first edge (101) of a pouch (100) to be lifted, wherein the stop (6) is preferably adjustable in the direction perpendicular to the conveying direction (x).

4. The device (1) according to claim 3, in which the minimum conveying width (b) is smaller by one dimension than a pouch height between pouch base (102) and opening (103) of a pouch (100) to be transported, around which the first edge (101) of the pouch (100) to be transported is to be lifted.

5. The device (1) according to claim 1, in which the conveyor (3) has a holding means (7), which is designed to hold a pouch (100) on a second edge (104) opposite the first edge (101).

6. The device (1) according to claim 5, in which the holding means (7) has a fixed height stop (8) and a first belt conveyor (9), which enclose between them a holding gap (10) extending in the conveying direction (x) for receiving the second edge (104).

7. The device (1) according to claim 1, in which the conveyor (3) has a first belt conveyor (9), which is in frictional engagement with a second edge (104) opposite the first edge (101).

8. The device (1) according to claim 1 in which the conveyor (3) is designed to stretch out the pouch (100), exclusively at the first edge (101), in its pouch plane, so that the first edge (101) is freely movable.

9. The device (1) according to claim 8, in which the conveyor (3) has a first belt conveyor (9), which engages on a second edge (104) opposite the first edge (101), and wherein the conveyor (3) has a second belt conveyor (11), which engages on the pouch (100) at a distance from the first edge (101).

10. The device (1) according to claim 6, in which the first belt conveyor (9) and/or the second belt conveyor (11) has a circulating cleated belt (12).

11. A pouch packaging machine with a circulation system (200) with a plurality of pouch grippers (201) spaced apart at a distance from one another in the transport direction of the circulation system (200), a pouch feed (300) and a device (1) according to claim 1, wherein the conveyor (3) opens in its conveying direction (x) downstream into an access region (202) of the circulation system (200), in which a pouch gripper (201) of the circulation system (200) comes into engagement with a lifted first edge (101) of a pouch (100) transported lying by the conveyor (3), wherein preferably the pouch grippers (201) are guided in a vertical plane along the circulation system (200), and wherein particularly preferably the pouch grippers (201) are guided in the access region (202) along a vertical circular path section.

12. A method for transferring pouches (100) from a pouch feed (300) to a circulation system (200) of a pouch packaging machine, comprising:
a) providing a plurality of pouches (100) arranged lying with a pouch feed (300);
b) sequentially transferring the lying pouches (100) to a device (1) according to claim 1;
c) transporting the pouches (100) lying with a conveyor (3) of the device (1) in a conveying direction (x); and
d) sequentially lifting a first edge (101) of the pouches (100).

13. The method according to claim 12, in which for said lifting the first edge (101) runs onto a ramp (5) or run-on slope rising along the conveying direction (x).

14. The method according to claim 12, in which for said lifting the first edge (101) is guided with the conveyor (3) along a stop (6) tapering the conveying width (b) of the conveyor (3) perpendicular to the conveying direction (x) in the conveying direction (x).

15. The method according to one of claim 12, which further comprises gripping the lifted first edge (101) of the pouch (100) with a pouch gripper (201) of the circulation system (200), wherein preferably the pouch grippers (201) are guided in a vertical plane along the circulation system (200), and wherein particularly preferably the pouch grippers (201) are pivoted along a vertical circular path section onto the lifted first edge (101).
